(19) United States
(12) Patent Application Publication
(10) Pub. No.: US 2006/0186567 A1
(43) Pub. Date: Aug. 24, 2006

(54) Electrically-conductive material based on a fluoro-polymer, and a method of fabricating such a material

(75) Inventor: David Cade, Langres (FR)

Correspondence Address: OLIFF & BERRIDGE, PLC, P.O. BOX 19928, ALEXANDRIA, VA, 22320, US

(73) Assignee: Compagnie Plastic Omnium, Lyon (FR)

(21) Appl. No.: 11/314,238

(22) Filed: Dec. 22, 2005

(30) Foreign Application Priority Data
Dec. 22, 2004 (FR) 04 13765

(51) Int. Cl. C04B 35/00; B27J 5/00

(52) U.S. Cl. 264/105; 264/127; 524/544

(57) ABSTRACT

A material, in particular an extruded material, e.g., in the form of a tape or a cylindrical rod, may be electrically conductive, based on fluoro-polymer, in particular PTFE, and contain a carbon-based conductive filler selected from: carbon black, carbon nanotubes, and carbon nanofibers.

The present invention relates to a conductive material based on a fluoro-polymer, in particular on polytetrafluoroethylene (PTFE), and to a method of fabricating such a material.

### BACKGROUND

Usually, a PTFE-based tape may optionally contain a filler.

For a tape made of pure PTFE, surface resistivity is about 10¹⁷ ohms per square, the tape then being completely electrically insulating.

It is also known to make a tape based on PTFE that has been filled with graphite. That type of tape presents electrical conductivity that is relatively mediocre.

### SUMMARY

The present invention seeks in particular to provide a material, in particular in the form of a tape, that is based on a fluoro-polymer, in particular on PTFE, and that presents improved electrical conductivity properties.

The invention thus provides a material, in particular an extruded material, e.g. in the form of a tape or a cylindrical rod, the material being electrically conductive, based on fluoro-polymer, in particular PTFE, and containing a carbon-based conductive filler selected from; carbon black, carbon nanotubes, and carbon nanofibers.

In the meaning of the present invention, the terms “nanotubes” and “nanofibers” are used to mean structures having a diameter lying in the range 1 nanometer (nm) to 10⁴ nm, and with a ratio of length/diameter that is high, e.g. greater than 100.

Such a material of the invention, with an appropriate content of conductive carbon, presents improved electrical conductivity properties.

When the filler contains carbon black, the percentage by weight of the conductive filler in the material may lie substantially in the range 2% to 8%, for example, and preferably in the range 3% to 6%, the PTFE being in fine powder form. The range is in particular about 5%.

When the filler contains nanotubes or nanofibers of carbon and the PTFE is in fine powder form, the percentage by weight of the conductive filler in the material lies substantially in the range 0.5% to 10%, for example.

Preferably, the percentage of conductive carbon filler in the material is selected in such a manner as to obtain a material presenting surface resistivity that is substantially less than 10⁸ ohms per square, e.g. less than 10⁵ ohms per square, for example being about 10⁵ or 10³ ohms per square.

In an embodiment of the invention, the material presents a single-layer structure.

The invention also provides a method of fabricating a material, in particular in the form of a tape or a cylindrical rod, that is conductive, and based on fluoro-polymer, in particular on PTFE, the method comprising the following steps:

providing a mixture containing a fluoro-polymer, in particular PTFE, and a carbon-based conductive filler selected from: carbon black, carbon nanotubes, and carbon nanofibers; and

forming the material by lubricated extrusion of the mixture.

The Applicant company has found that lubricated extrusion applied to a mixture of PTFE with a carbon-based conductive filler in accordance with the invention, in appropriate proportions as a function in particular of the grade of the fluoro-polymer, makes it possible firstly to ensure extrusion conditions that are satisfactory, and secondly to obtain a material presenting improved electrical properties, in particular relatively high electrical conductivity, in particular electrical conductivity that is higher than that of a PTFE tape filled with graphite.

The PTFE in the mixture is not sintered.

In a particular implementation of the invention, carbon black is used as the filler and the percentage by weight of the conductive filler in the mixture lies substantially in the range 2% to 8%, for example, preferably in the range 3% to 6% for PTFE in fine powder form. This range is in particular about 5%.

In an implementation of the invention, the extrusion is performed using a die selected to obtain an extruded tape at its outlet having thickness that lies in the range 30 micrometers (μm) to 500 μm, in particular in the range 80 to 150 μm, e.g. about 100 μm.

The method may include at least one of the following steps:

subjecting the extruded material to calendaring;

eliminating the lubricant from the extruded material;

subjecting the extruded material to baking, e.g. while eliminating the lubricant; and

optionally dedensifying the extruded material, in particular by stretching.

The invention also relates to a method for producing a tube based on fluoro-material, the method comprising:

winding on a mandrel a tape of material as disclosed above, such as to form overlapped layers,

heating the winded tape to a temperature greater than a gelling temperature of the fluoro-material, during a period sufficient to cause gelling,

cooling the tube,

extracting the tube formed by the fluoro-material from the mandrel.

It is possible to refer to application EP 524 893 concerning the performing of the above-mentioned method.

### BRIEF DESCRIPTION OF THE DRAWING

The invention can be better understood on reading the following detailed description of non-limiting embodiments thereof and on examining the accompanying drawing, in which:

FIG. 1 is a diagrammatic fragmentary view showing the steps of a method of fabricating a tape in accordance with the invention; and

FIG. 2 is a diagrammatic and fragmentary view showing a step of dedensifying a tape.

### MORE DETAILED DESCRIPTION

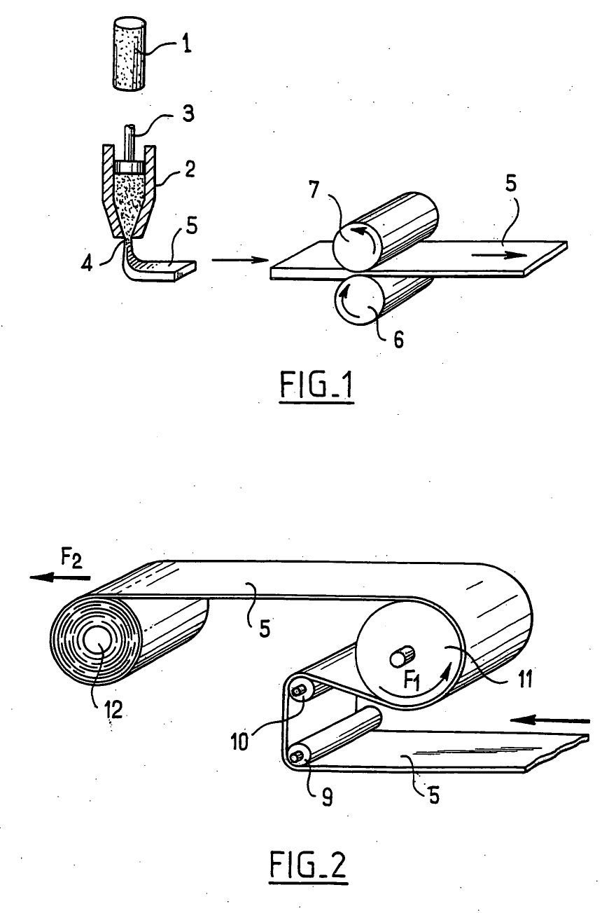

The various steps of a method of fabricating a PTFE-based conductive material in accordance with the invention is initially described with reference to FIGS. 1 and 2.

The method begins by preparing a preform 1, e.g. of cylindrical shape, obtained by compacting a mixture of non-sintered PTFE in fine powder form and of lubricant, also incorporating a carbon-based conductive filler.

The preform 1 is introduced into an extrusion press 2 having a piston 3 for driving the mixture through a die 4.

In the example described, the die 4, in particular comprising a slot, is selected in such a manner as to obtain at its output material in the form of a flat tape 5 having thickness lying in the range 30 μm to 500 μm, e.g. about 100 μm.

In a variant, the die may be arranged to extrude a cylindrical rod.

The extruded tape 5 may then be fed between two calendaring cylinders 6 and 7 in order to reduce its thickness.

In a step that is not shown, the tape 5 is dried in order to eliminate the lubricant.

Optionally, the density of the tape 5 can be further reduced in a step as shown in FIG. 2 which consists in dedensifying the tape 5.

During this step, the tape 5 is brought via deflector rollers 9, 10 onto a drum 11 that is rotated about its axis in the direction of arrow F₁.

Where necessary, the drum 11 includes a heater device enabling its outside surface to be maintained at an adjustable constant temperature.

After passing over the drum 11, the tape 5 can be wound onto a core 12 associated with a drive device (not shown) arranged to enable the traction force F2 exerted on the tape to be adjusted at will.

There follow descriptions of implementations of the method of the invention.

### EXAMPLE 1

The mixture for extrusion contained:

natural raw PTFE powder: 100 parts by weight;

carbon black: 5 parts by weight; and

Isopar (registered trademark) lubricant: 25 to 30 parts by weight.

The extrusion pressure was about 40 bars to 100 bars.

The extrusion temperature lay in the range 30° C. to

The resulting tape 5 presented thickness of about 100 μm, relative density of about 1.5, and surface resistivity of about 10⁵ ohms per square.

### EXAMPLE 2

The mixture for extrusion contained:

natural raw PTFE powder: 100 parts by weight;

filler based on carbon nanotubes: 0.5 parts by weight; and

Isopar (registered trademark) lubricant: 25 parts by weight.

### EXAMPLE 3

The mixture for extrusion contained:

natural raw PTFE powder: 100 parts by weight;

filler based on carbon nanotubes: 1 part by weight; and

Isopar (registered trademark) lubricant: 25 parts by weight.

Naturally, it is possible to use any suitable lubricant other than that specified in the above examples.

What is claimed is:

1. A material that is electrically conductive, based on PTFE, and contains a conductive filler of carbon black, wherein a percentage by weight of the conductive filler in the material lies substantially in a range of 3% to 6%, and wherein the PTFE is in fine powder form.

2. A material according to claim 1, wherein the percentage by weight of the conductive filler in the material is about 5%.

3. A material according to claim 1, comprising a tape, wherein a thickness of the material is between about 80 μm and about 150 μm.

4. A material according to claim 1, wherein the percentage by weight of the conductive filler in the material is selected in such a manner as to obtain a material including a surface resistivity that is substantially less than 108 ohms per square.

5. A material according to claim 1, wherein the material comprises a single-layer structure.

6. A method of fabricating a material according to claim 1, the method comprising:
providing a mixture containing a fluoro-polymer and a conductive filler based on carbon black, and
forming the material by lubricated extrusion of the mixture.

7. A method according to claim 6, wherein the mixture contains PTFE in fine powder form.

8. A method according to claim 7, in which the filler is carbon black, wherein a percentage by weight of the conductive filler in the mixture lies substantially in a range of 2% to 8%.

9. A method according to claim 6, the extrusion being performed by a die selected so as to obtain at an outlet thereof an extruded tape including a thickness lying in a range of 30 μm to 500 μm.

10. A method according to claim 6, further comprising at least one of:
subjecting the extruded material to calendaring;
eliminating a lubricant from the extruded material;
subjecting the extruded material to baking; and
dedensifying the extruded material.

11. A method for producing a tube based on fluoro-material, the method comprising:
winding on a mandrel a tape of material according to claim 1, so as to form overlapped layers,
heating the wound tape to a temperature greater than a gelling temperature of the fluoro-material, during a period sufficient to cause gelling,
cooling the tube, and
extracting the tube formed by the fluoro-material from the mandrel.

12. A material that is electrically conductive, based on fluoro-polymer, and containing a conductive filler of carbon nanotubes.

13. A material that is electrically conductive, based on fluoro-polymer, and containing a conductive filler of carbon nanofibers.

14. A material according to claim 1, wherein the material comprises an extruded material.

15. A material according to claim 14, wherein the extruded material comprises at least one of a tape and a cylindrical rod.

16. A material according to claim 12, wherein the material comprises an extruded material.

17. A material according to claim 16, wherein the extruded material comprises at least one of a tape and a cylindrical rod.

18. A material according to claim 13, wherein the material comprises an extruded material.

19. A material according to claim 18, wherein the extruded material comprises at least one of a tape and a cylindrical rod.

20. A material according to claim 13, wherein the fluoro-polymer comprises PTFE.
